(19) United States
(12) Patent Application Publication
(10) Pub. No.: US 2009/0241042 A1
(43) Pub. Date: Sep. 24, 2009

(54) Method and apparatus for controlling and operating computers used in vision screening and correction as well as other applications utilizing remote control or dual visual outputs

(75) Inventor: Steven B. Nordstrom, Hinsdale, IL (US)

Correspondence Address: MCANDREWS HELD & MALLOY, LTD, 500 WEST MADISON STREET, SUITE 3400, CHICAGO, IL, 60661, US

(73) Assignee: NORDSTROM CONSULTING, INC., Burr Ridge, IL (US)

(21) Appl. No.: 12/077,321

(22) Filed: Mar. 18, 2008

(51) Int. Cl. G06F 3/048

(52) U.S. Cl. 715/762; 715/764

(57) ABSTRACT

A method and apparatus for facilitating an end user to assign buttons or keys of a remote control device to operate a computer to provide desired displays or operate desired programs including third party programs and functions and a method and apparatus for isolating or filtering the input and operation of an application software using a remote control from the application or a user interface level of Microsoft Windows so that the application is not required to be the “active application” i.e. have “focus” in Windows and allowing other applications to be operated by the user simultaneously with the vision testing software.

### RELATED APPLICATIONS

This application claims the benefit of U.S. Provisional Application No. 60/918,585, filed Mar. 16, 2007, the contents of which all are incorporated herein by reference.

### FIELD OF THE INVENTION

The present invention relates generally to remote control and operation of a computer and one or more displays driven by said computer, in particular those computers used to facilitate vision testing and/or correction.

### BACKGROUND OF THE INVENTION

In the fields of optometry and ophthalmology, it is advantageous for a practitioner to have in the patient examination room: visible charts, projection images of eye charts or computerized presentations of eye charts and other vision testing indicia, at either a convenient, or a medically prescribed distance from the patient in order to conduct an examination or therapy. When a computer is used to display images at these distances, it can be problematic because the practitioner has to be close to computer to operate its display as opposed to being close to the patient which is often ideal. Computerized systems may limit a practitioner's ability to be close to the patient while controlling the computer generated displays necessary for treatment or testing.

To mitigate these problems, some have proposed remote control devices to control computer generated displays for vision testing to allow the practitioner to stay close to the patient during examination or treatment. But to date, these remote controls share one or more deficiencies. For example, in order to provide selection between, or operation of, all of the tests and displays desired or necessary, a remote control must have a great number (for example 50 or more) buttons or keys that are, by necessity, small, crowded and difficult to use. Alternatively, others have proposed remote controls with pre-assigned control keys which alleviate crowding but result in a very large remote control unit. Optionally others have proposed units having limited keys which then require the user to navigate through screens on the video display of the computer to access the many displays and tests required by pressing various keys a number of times.

In addition, there are many tests designed for use by medical specialists (e.g. pediatric, retina, low-vision, refractive surgeons, etc.) which are not necessarily of general interest in the industry. Thus a standardized remote control satisfying a general regime of tests or therapy would not meet the needs of these specialists and a special control regime and attendant remote control would be necessary to meet the needs of their medical practice.

Other than by complex editing of configuration files of the computer generating the desired displays, no current system provides the optometric/ophthalmic practitioner with a remote control device of convenient size and necessary range of choices to conduct examinations and treatment in a robust range of conventional or exceptional visual displays for this purpose.

In addition to the above, in the optometric/ophthalmic industry, electronic equipment used in vision testing has comprised a projector that projects an eye chart on the wall or, a computerized system that presents vision tests on a monitor connected to a dedicated microcomputer. In many of the existing computerized systems, the microcomputer is built into the case containing the display and there is no provision for connecting a keyboard or mouse. This places the entire unit on the wall in the examination room and renders the computer useless for any application other than the visual acuity tests.

A few existing vision testing systems utilize a standard microcomputer but, when used with an infrared remote control, the input is received by, or sent to, the application or user interface level of the Windows operating system. While this allows other programs to be running on the computer, it does not allow the simultaneous use of the vision testing system and other applications because the input from the infrared remote control is routed to the currently active application; the application having “focus.” In order for these systems to function correctly, the user must use a mouse to “click” on a component of the application that is to receive input from the keyboard, mouse or, the remote control. Failing to do this causes input from the remote control, keyboard or mouse to be received by whatever program has “focus.” In most cases, input from the keyboard or mouse is undesirable or unnecessary for the vision testing system if it was designed to be controlled by an infrared remote control. Conversely, input from the infrared remote control is usually undesirable if it is inadvertently received by another program such as medical records software, running on the same CPU or computer.

The following preexisting systems, which are incorporated herein disclose prior visual testing systems which do not solve the problems discussed above: U.S. Pat. No. 5,121,981 to Waltuck et al., U.S. Pat. No. 5,880,814 to McKnight et al., U.S. Patent Publication No. 2004/0141152 to Marino et al., and, U.S. Patent Publication No. 2004/0036840 to Marino et al.

The present invention is intended to provide solutions to the above-noted deficiencies in the art and to provide additional functionality for remote control of a computer running various programs and having one or more screen display outputs.

### SUMMARY OF THE INVENTION

In an embodiment, the present invention provides for a method and apparatus for user assigned and/or activated controls, such as buttons or keys on a remote control to operate a computer to provide desired output displays or to operate desired programs and functions.

In another embodiment of the invention, a software or hardware configuration is provided which isolates the input and operation of an application software using a remote control from the application or a user interface level of Microsoft Windows so that the application is not required to be the “active application” i.e. have “focus” in Windows and allowing other applications to be operated by the user simultaneously with the vision testing software.

### BRIEF DESCRIPTION OF THE DRAWINGS

The present invention may be more clearly understood from the following detailed description considered in conjunction with the following drawings, in which like numerals represent like elements and in which:

FIG. 1 illustrates a vision testing system in accordance with the present invention; and,

FIG. 2 is a window for reconfiguring program buttons on the remote control of FIG. 1;

FIG. 3 is an example of button assignments for the programmable buttons on the remote control of FIG. 1;

FIG. 4 is a code listing of a module for handling programmable button input;

FIGS. 5A-B are a code listing of a module for executing the function of internal codes;

FIG. 6 is a code listing for a data wall interface wherein Windows message handler is shutoff and replaced with another handler;

FIGS. 7A-C is a code listing for registering the remote control;

FIG. 8 is a window for selecting an external program;

FIG. 9 is a code listing for sending control commands to the external program;

FIG. 10 is diagram illustrating the process of assigning buttons or keys of a remote control device to various functions recognized by a computer; and,

FIG. 11 is a flow chart illustrating the logistics of a method according to an embodiment of the invention.

While the invention is susceptible of various modifications and alternative constructions, certain illustrated embodiments hereof are shown in the drawings and will be described below. It should be understood, however, that there is no intention to limit the invention to the specific forms, uses, or ophthalmic applications disclosed. To the contrary, the invention is to cover all modifications, alternative constructions, uses, applications, and equivalents falling within the spirit and scope of the invention as defined by the appended claims.

### DESCRIPTION OF THE PREFERRED EMBODIMENTS

Many visual acuity systems on the market can be controlled by a remote control. The remotes in the prior systems are either exceptionally large, are driven by manipulation of one or more keys on the remote device to navigate through a menu such as on a computer screen so as to access a given single test, or require the manufacturer to pre-assign vision tests to keys specific to a practice.

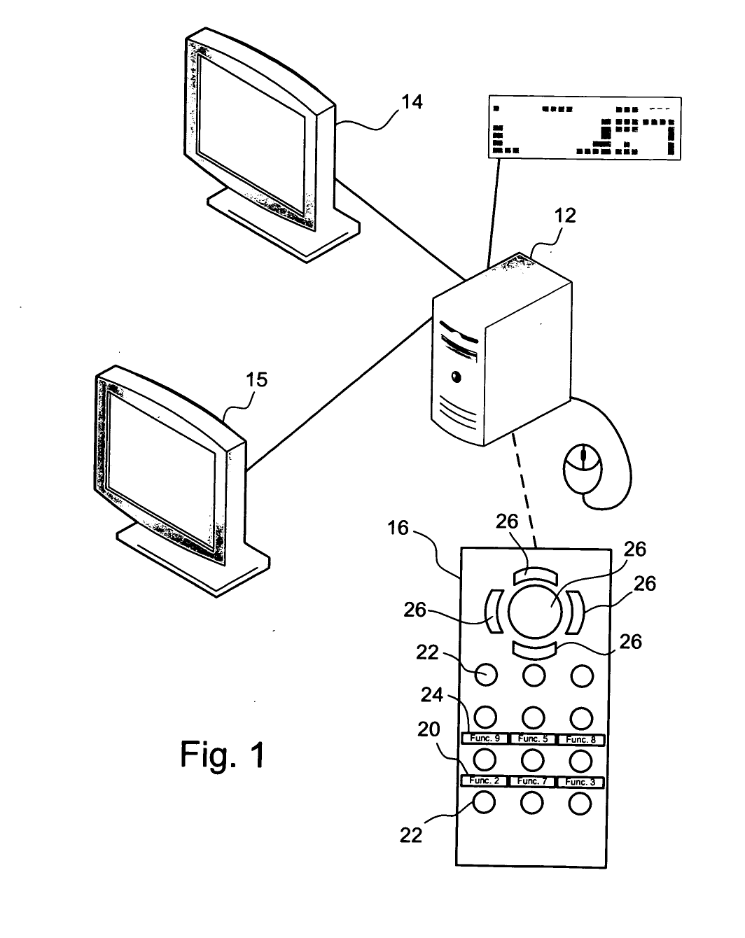

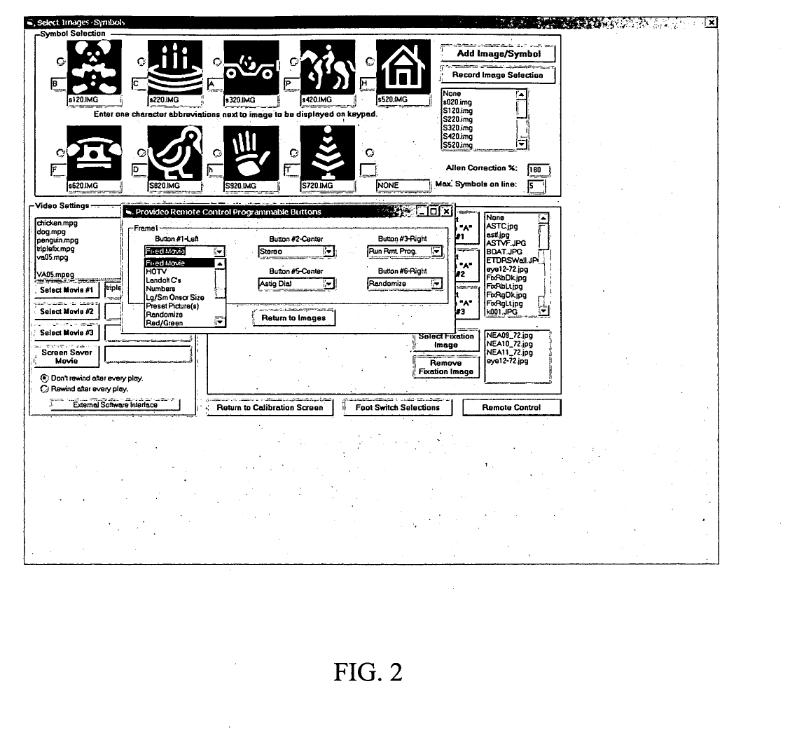

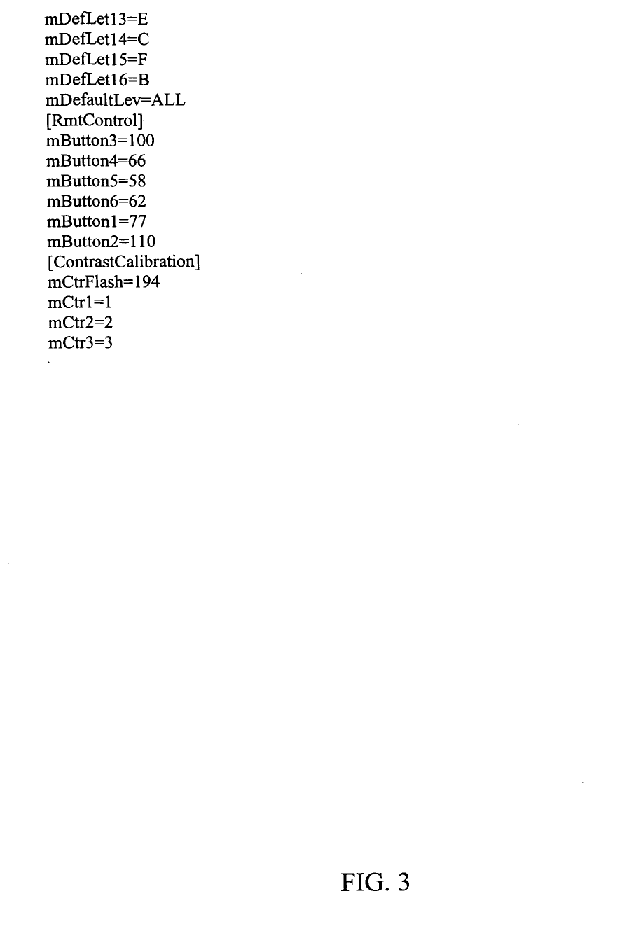

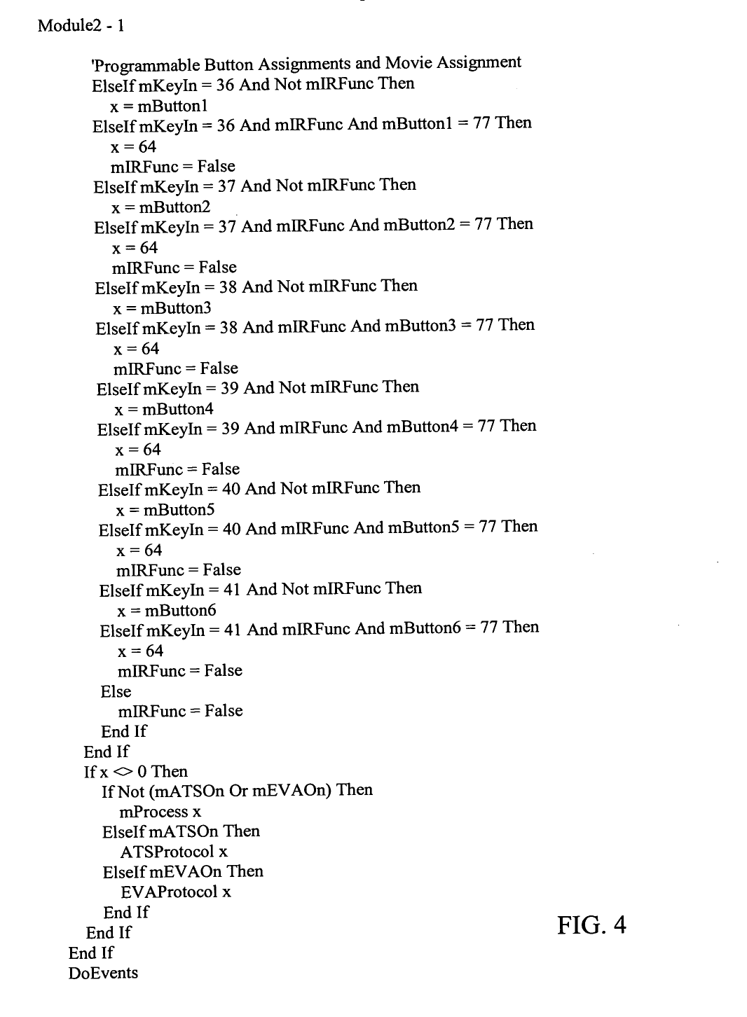

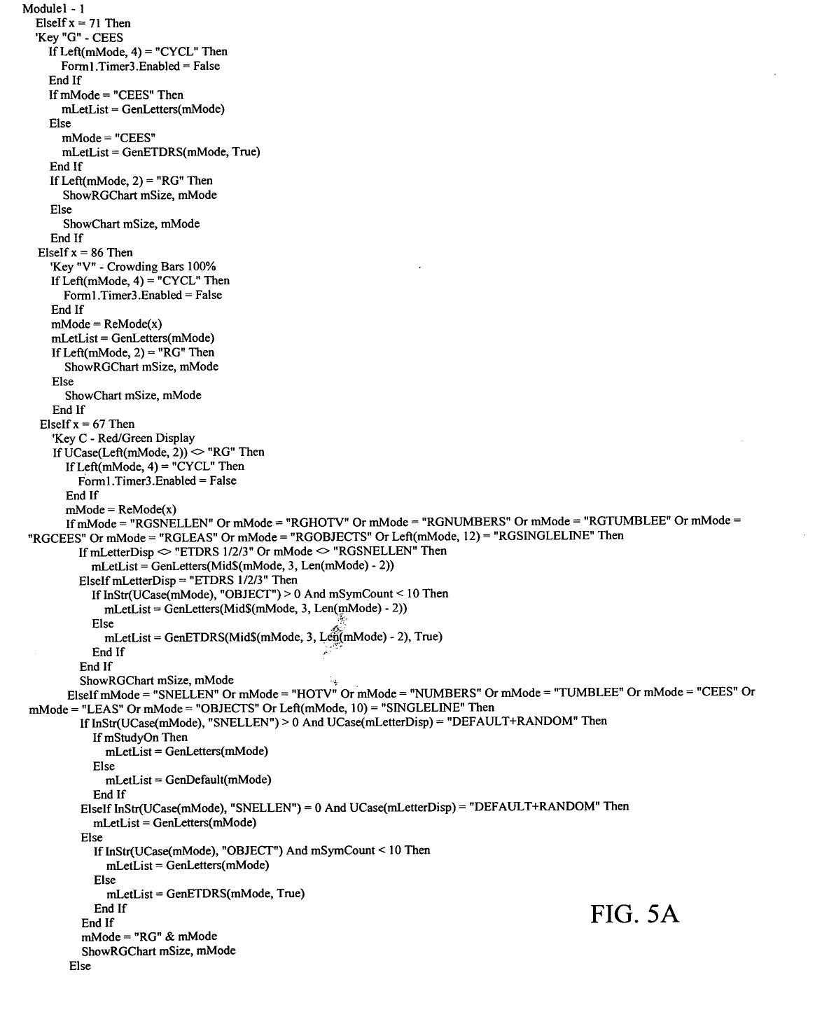

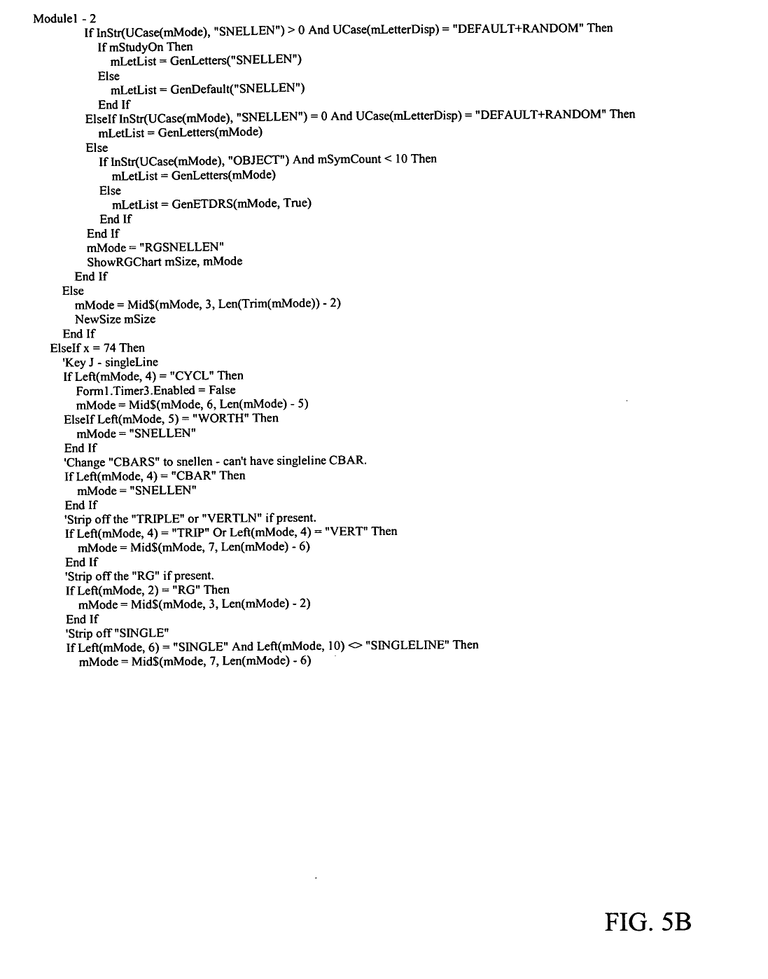

In an aspect of the invention, this problem is addressed by reserving a desired number of buttons on the remote control device wherein their function is assignable by the end-user. In an embodiment, software on the device to be controlled provides a configuration screen or window such as depicted in FIG. 2 wherein the user can select the button on the remote to be assigned and then select the operation or function to be assigned from a pull-down menu for example, using a keyboard and/or mouse. FIG. 3 depicts an example of button assignments for the programmable buttons on the remote control of FIG. 1. Further, FIG. 4 is a code listing of a module loaded on the computer of FIG. 1 for handling programmable button input. Moreover, FIGS. 5A-B is a code listing of a module loaded on the computer of FIG. 1 for executing the function of internal codes.

Preferably, once the function has been assigned to the button on the remote control, it can still be re-assigned at a later time by the user in the same fashion. Day to day operation of the vision testing software can be controlled by the remote. Preferably, however, the system keyboard or mouse is used to configure the remote via the configuration screen.

Turning to FIG. 1, and stated another way, the present invention provides a user assignable remote control wherein the doctor or user can assign specific functions to buttons on the remote control. In FIG. 1, the system includes a conventional computer 12 connected to a display or monitor 14 wherein the computer is response to signals transmitted from the remote control 16.

The remote control 16 has a plurality of buttons 22 wherein the remote control transmits a unique code associated with each button when depressed. Accordingly, the assigned function is performed by the system, and in particular the computer 12, when the button is depressed on the remote. The function assigned to a button can be selected from a plurality of assignable functions that are provided on a pull-down screen displayed on the monitor 14. Thus, the present invention provides for a compact remote control that is tailored to the needs of a physician or specialist. This is a result of providing for configuration of the remote control to serve special testing procedures or the desires of the physician.

Functions that can be assigned to the buttons include, but are not limited to, showing of movies, displaying of charts, executing software modules, and the like. In an alternative embodiment, the buttons on the remote (e.g., the bottom row of buttons) can be assigned to reconfigure other buttons on the remote to perform various steps of a specific task or function.

In an embodiment, stickers 24 can be used to indicate the function assigned to a button on the remote control 16. For instance, the stickers 24 can be provided on a sheet wherein the stickers can be blank or have indicia preprinted thereon such as commonly used functions or visual tests. Thus, the stickers can be removed from the sheet and placed about the buttons on the remote that have been assigned a particular function.

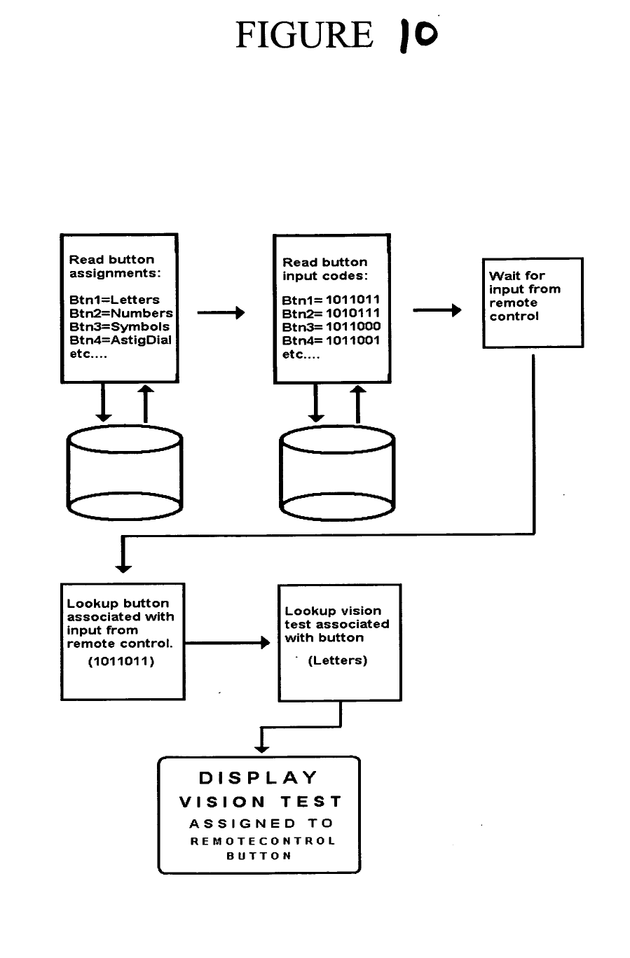

In another embodiment of the invention disclosed in FIG. 10, a remote control (not shown) has 42 buttons/keys. The topmost 36 buttons on the remote are pre-assigned with functions that are commonly used in vision testing. Six buttons on the remote control unit are user-programmable. The technique for assigning vision tests or functions to buttons/keys on the remote control may be easily extended to any number or all of the buttons present. In the present embodiment, both the pre-assigned buttons on the remote control and the user programmable buttons function, in general, as follows:

1. At startup, the system reads into memory a configuration file that contains a number or label describing the test or function assigned to each button on the remote control. This includes the pre-assigned buttons as well as the buttons to which the user has assigned functions.

2. At startup, a set of configuration data is also loaded that identifies each button on the remote control by its unique infrared signal. In the present embodiment, multiple input devices (remote controls, keypads, footpedals, etc.) are each defined in the software so that the appropriate subroutine, on receiving an input signal, returns the identity of the button or key pressed.

3. When a button on the remote control is pressed, the remote control transmits an infrared signal that uniquely identifies the button pressed.

4. The system receives the signal from the remote control through an infrared receiver attached to the computer.

5. The software uses the received signal to identify the physical button pressed on the remote control.

6. The software then queries the list of assigned functions for the test/function assigned to that physical button.

7. The software then displays the appropriate screen from the assignment identified in step #6 (above).

In the above-described embodiment of the invention, six buttons/keys of the remote control were selected for user programmability. However, any number of buttons, including all of them, can be rendered programmable by equipping the software with a screen containing selection capability for each of the programmable buttons.

Other acuity systems and vision chart projection systems use remote controls that have the buttons linked to the device in such a manner as to produce a specific chart or vision test when a specific button is pressed. One such system, developed by this author, uses a configuration file stored on the computer's hard disk that allows factory configuration. In this system, any chart or vision test may be assigned to any button on the remote control by pre-assigning codes representing the charts and tests to variables in the configuration file representing buttons on the remote control. This is unlike the present invention in that in order to program the previous system, the user would have to know the codes that will produce specific charts and tests, edit the configuration file manually and assign the correct codes to the correct variables. This is not an operation that the vast majority of the users of these systems could successfully accomplish.

The present invention solves this problem by allowing the user to select a chart, vision test or function from a “pull-down” list or, individual lists for each key, in the program's setup screen and associate this test with a programmable button on the remote control. The program then saves the users' selections to the stored configuration file on the computer's hard disk and loads these selections at start-up.

Again, a sheet of labels are preferably provided, listing all of the functions available in the system, that may be applied to the face of the remote control by the user once they have selected the tests to be assigned to the user-programmable buttons.

In another embodiment of the present invention, an ophthalmic vision testing software application is controlled with a USB remote wherein the remote control can activate third party software from within the vision testing software. In an embodiment, the feature of activating third party software is turned on using a specified button on the remote control 16, which in turn allows the remote to take on a different set of commands, including several navigational buttons 26. The navigation buttons allow the remote 16 to function similar to mouse movements, with both large and small movements defined without the use of a keyboard or mouse. This feature therefore allows the control of third party software without a separate interface. Thus, the invention prevents the need to exit a visual acuity exam or other process to execute the third party software. In an embodiment, the third party software can include, but is not limited to, interactive graphics such as a retina image or a patient education program.

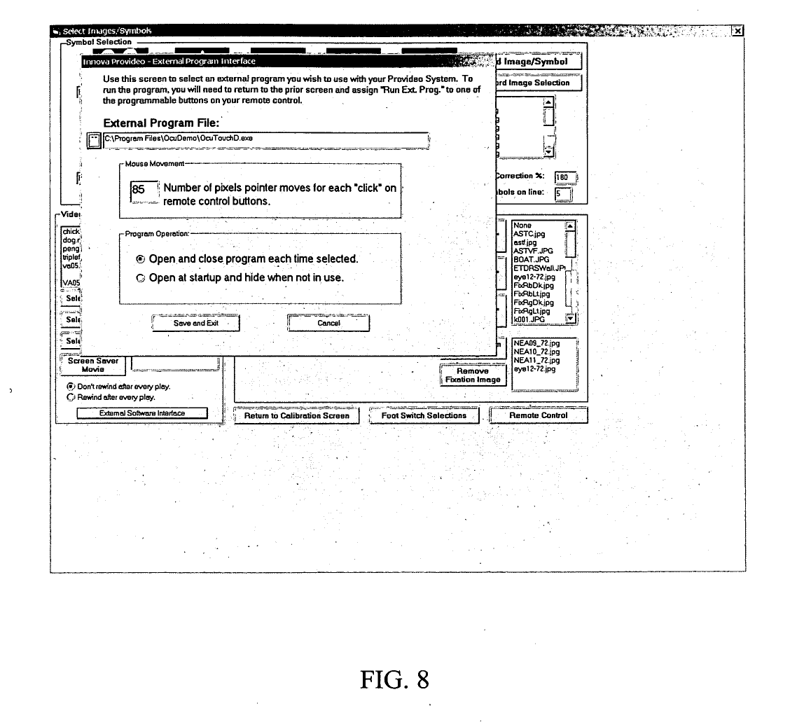

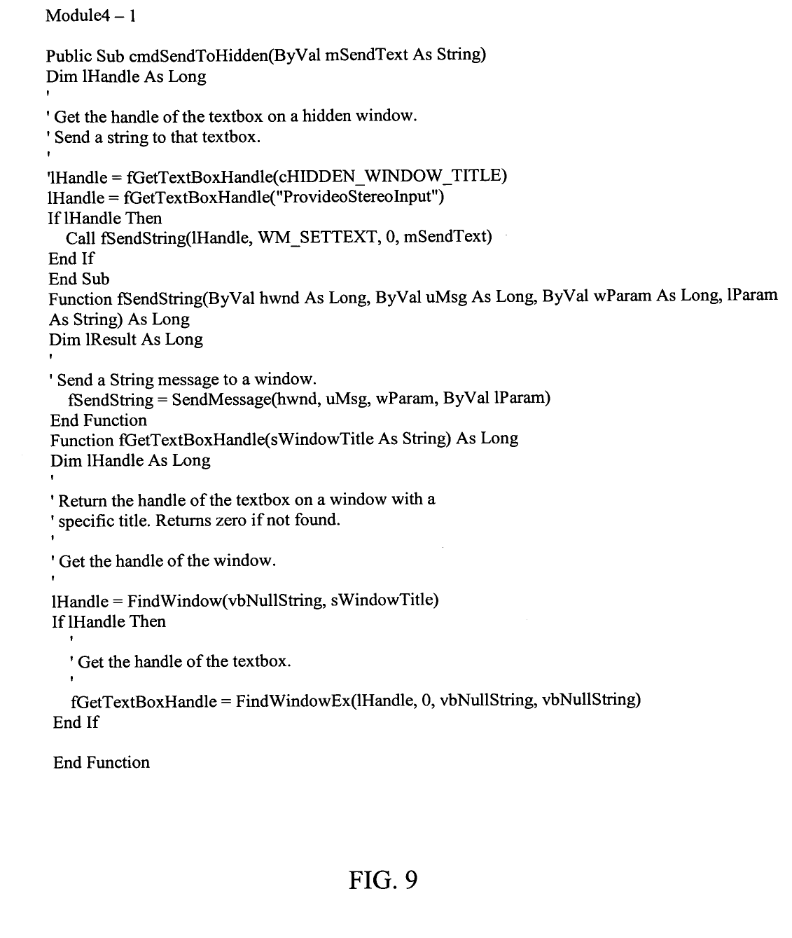

Turning to FIG. 8, a window is depicted in accordance with the present invention for selecting, via the remote 16, an external program. The window can be displayed on one or both of the monitors 14 and 15. Moreover, FIG. 9 provides a code listing loaded on the server or CPU 12 for sending control commands to the external program. As used herein, an external program is a program accessible by the server or CPU 12, but not a part of the vision testing or screening software loaded on the server or CPU. An exemplary command structure would be to:

1. Send cursor commands to move mouse;

2. Send “click” commands to execute functions within remote program;

3. Send “F-keys” to run pre-set videos in a program such as Eyemaginations®; and,

4. Reposition Eyemaginations® screen from monitor #1 to monitor #2 or vice versa, i.e. “swap screens.”

The method of controlling the third party software features operates by executing, from within the vision testing software, the command to run any external program that has been pre-selected by the user. At the time the program is loaded, the “file handle” (a unique number that is assigned by the operating system to identify any running program) is identified and captured by the vision testing software.

Notably, in this or other embodiments, the vision testing software can send any command to the external program that could be input by the user with a keyboard and/or mouse. Also, any command can be associated with a button on the remote control and sent to the external program by pressing the button on the remote control. In addition, the vision testing software can execute any operating system function on the external program including: minimizing it, maximizing or restoring it on the screen, terminating the external program, repositioning it on the screen or, moving the program's displays from one monitor to another.

In another embodiment, the present invention can be used to control hardware such as but not limited to, a CD and DVD player operatively connected to the CPU 12 or integral thereto.

As noted above, all visual acuity programs known to the inventor interfere with other software applications active on the same computer due to remote control signals. Accordingly, there is a need for a visual acuity system that will allow other software applications to run on the same computer without interference from the visual acuity or testing system.

Accordingly, in an aspect of the present invention, software is provided that requires no traditional Microsoft Windows user-level interface activity in normal operation. As such, it generates no activity at the Microsoft Windows user interface level that could cause interaction with any other software running on the same computer 12.

In an embodiment, the remote control interface incorporated into the visual acuity system software intercepts input signals from the Universal Serial Bus (USB) port and processes signals from the remote control within the software and releases all other activity back to Windows. In this embodiment, a conventional remote receiver (not shown) is connected to the server 12 via the USB port

The software is designed specifically so that the vision testing software and third party software packages may reside on the same CPU or sever 12 without interference. The software does not emit typical remote control signals that could interfere with other software packages on the same hardware. Moreover, the software utilizes remote control driver from supplier.

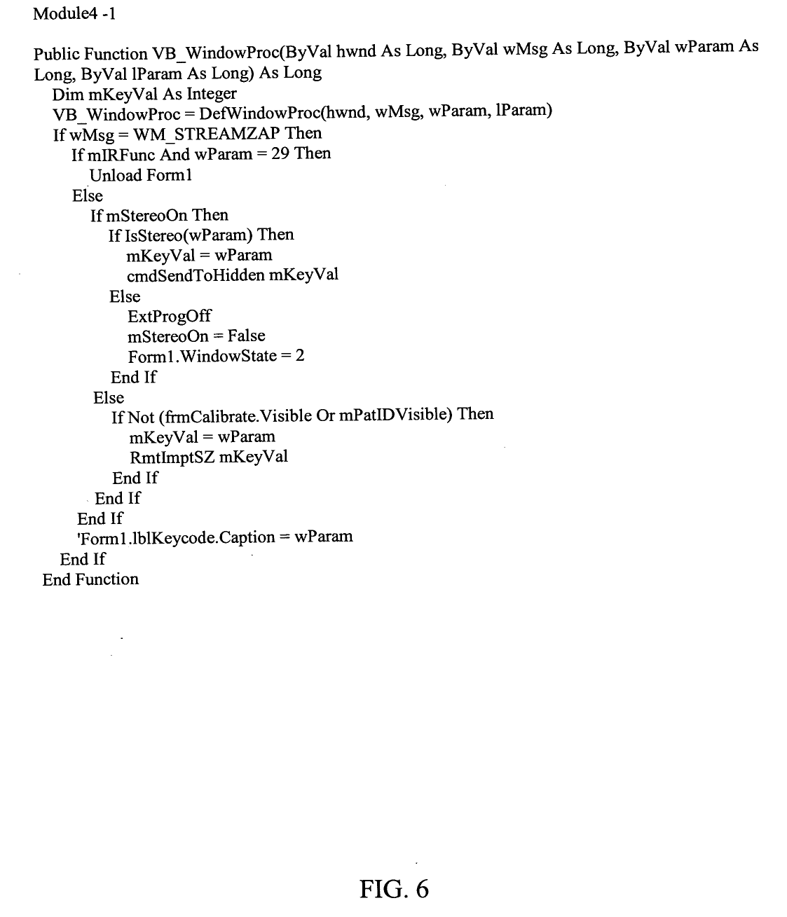

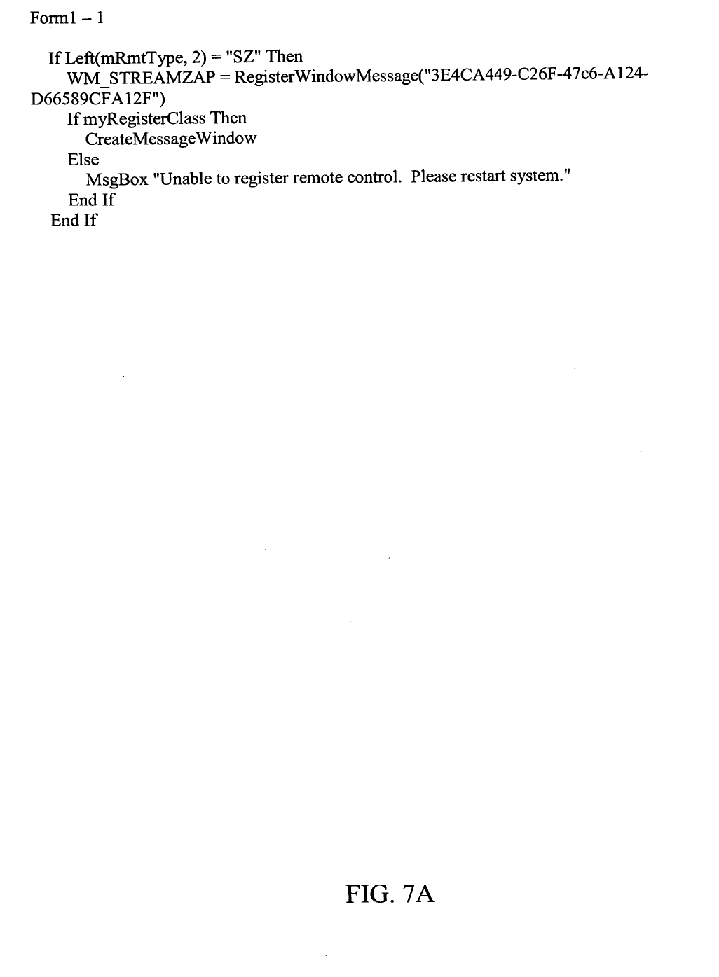

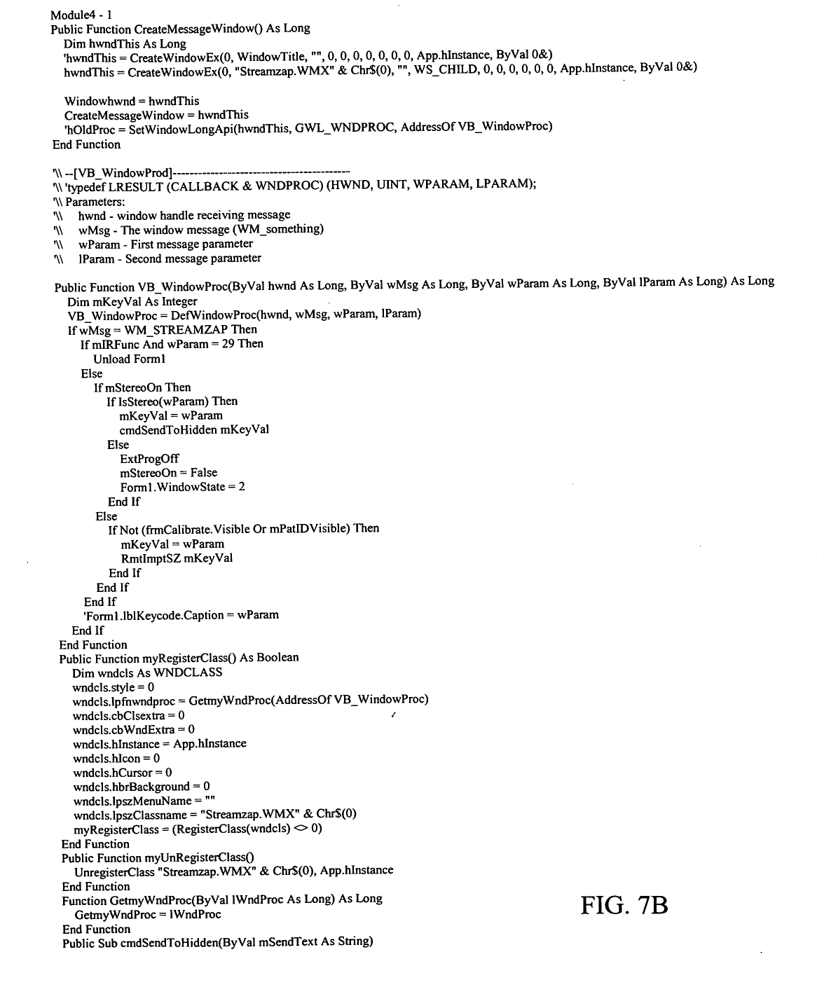

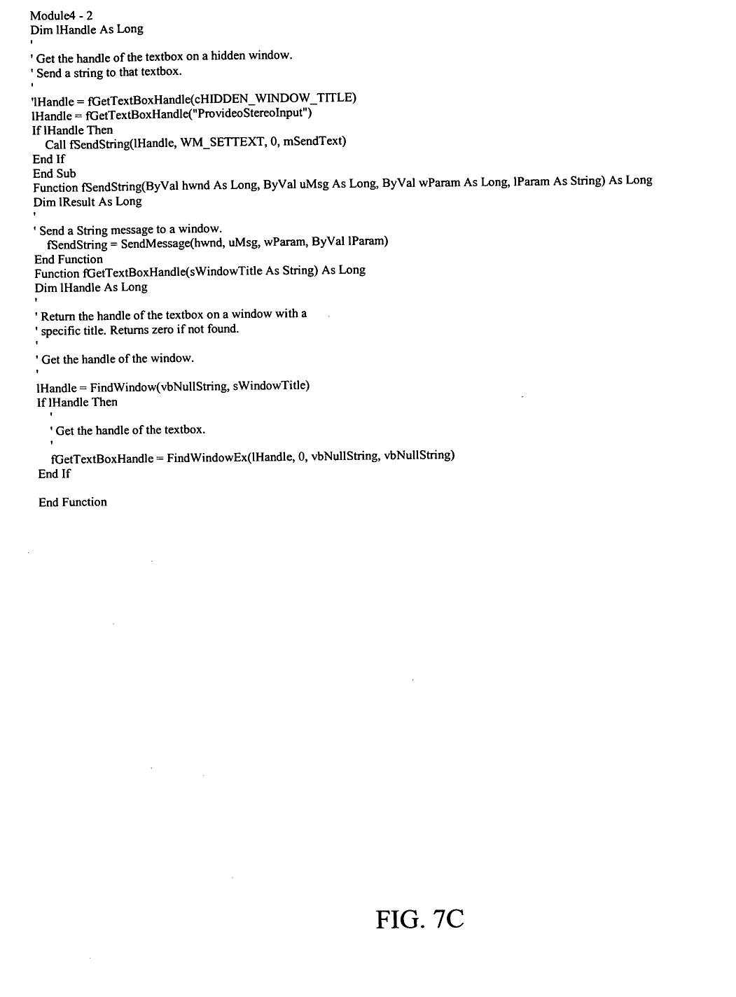

In an embodiment, the system allows for at least a pair of monitors 14 and 15. One of the monitors can be used for conducting a vision test via an application, while the other monitor can be used for conducting other activity such as, but not limited to, scribing data regarding the testing results via another application such as, but not limited to Microsoft typepad. In an embodiment, a system similar to Microsoft Windows messaging can be used. Turning to FIG. 6 a code listing is depicted for a data wall interface in accordance with the present invention and loaded on the server or CPU 12 wherein the Windows message handler is shutoff and replaced with another handler. Moreover, FIGS. 7A-C is a code listing for registering the remote control 16. Accordingly, commands from the remote control 16 are performed or processed before other applications or systems.

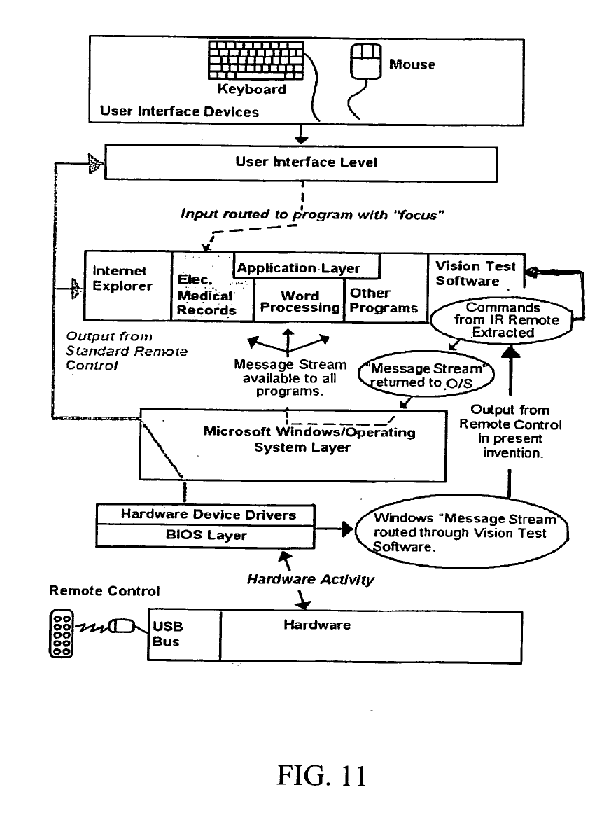

FIG. 11 discloses the software and hardware logistics of an embodiment of the present invention which intercepts an input from the infrared remote control before it reaches the routing mechanism of the Windows operating system and preventing it from being made available to other applications and/or being routed to the user interface. This allows the vision testing software to receive the input from the remote control and execute commands without the vision testing software being the “active application” or, having “focus”. In fact, this allows the vision testing software operate without “focus”, freeing the computer resource for simultaneous use with other programs.

### See Exhibit A2

As disclosed in FIG. 11, this isolation of the vision testing software from other running applications may be accomplished using a combination of three mechanisms:

1. An infrared remote control along with a suitable infrared detector or receiver which is connected to the Universal Serial Bus (USB) with a standard USB connector;

2. A software program or “driver” (supplied by the manufacturer of the remote control) that intercepts traffic from the remote control's infrared detector/receiver which is attached to the Universal Serial Bus (USB)—this program “captures” the incoming signal from the remote control and releases the input as a “Windows Message” with a code attached to the message identifying it as input from the remote control; and,

3. A software module, which is part of the vision testing software, that intercepts the entire Windows operating system's “message stream”, removes the messages generated by the remote control and, then releases all unrelated “messages” back into the Windows operating system for normal processing.

It should be noted that, low level activity from hardware devices, activity initiated by Windows and some activity initiated by running applications is “broadcast” at a “background” level in the operating system as “packets” of data accompanied by a unique code identifying the source of the “message”.

In an aspect of the invention, the vision testing software is loaded onto the CPU 12 that incorporates a series of distance stereo test in a modular format instead of using the convention method of using paper charts or graphs. Unlike previous acuity systems, the distance stereo test of the present invention may be displayed on an LCD monitor utilizing colored glasses (i.e., glasses having different colored lens), instead of shuttered glasses. The distance stereo test allows the doctor to test stereopsis, establish accurate thresholds and determine eye dominance. The wide range of separations and small separation increments allows accurate monitoring of the patient's progress.

In an embodiment of the invention, specific distance stereo tests in accordance with the present invention include a flittering butterfly (i.e., the butterfly is animated), eye dominance, and forced choice quadrant tests such as symbols, random dots, rings, and reverse rings. In the animated example, such as the butterfly, a user can observe if the patient, such as a child, pokes or grabs at the butterfly to determine if the patient is seeing in three dimension.

Moreover, the user (i.e., doctor or clinician) has the option to select the specific quadrant with each display of a forced choice test or the quadrant may be selected randomly by the software.

In an embodiment, automated, scripted tests may be performed by the user to ensure repeatability over time and over many different operators. The script processor allows scripted tests to be designed by the user for repeatable results. Results may be printed for comparison over time to monitor progress. Moreover, the user can be provided with controls to change the angle of separation to determine the severity or progress of the patient.

In an embodiment, both distance stereo and visual acuity are controlled by a single remote 16. Distance stereo can be activated on the remote through a specified button. This button, when depressed, reconfigures the remote keys to operate the distance stereo functions.

What is claimed is:

1. A method comprising: facilitating an end user to assign buttons or keys of a remote control device to operate a computer to provide desired displays or operate desired programs and functions.

2. A computer system comprising:
a remote with user activated controls, such as buttons or keys, the remote being configured to permit a user to assign buttons or keys to operate a computer to provide desired displays or operate desired programs and functions.

3. A method comprising:
isolating or filtering the input and operation of an application software using a remote control from the application or a user interface level of Microsoft Windows so that the application is not required to be the “active application” i.e. have “focus” in Windows and allowing other applications to be operated by the user simultaneously with the vision testing software.

4. A computer system comprising:
a software or hardware configuration which isolates the input and operation of an application software using a remote control from the application or a user interface level of Microsoft Windows so that the application is not required to be the “active application” i.e. have “focus” in Windows and allowing other applications to be operated by the user simultaneously with the vision testing software.
